(19) United States
(12) Patent Application Publication
(10) Pub. No.: US 2012/0021120 A1
(43) Pub. Date: Jan. 26, 2012

(54) COATINGS WITH IDENTIFICATION AND AUTHENTICATION PROPERTIES

(76) Inventor: Michael David FELDSTEIN, Princeton, NJ (US)

(21) Appl. No.: 13/187,619

(22) Filed: Jul. 21, 2011

Related U.S. Application Data
(60) Provisional application No. 61/400,203, filed on Jul. 23, 2010.

(51) Int. Cl. B05D 5/00; B05D 3/00; B05D 5/06; C09D 1/00; B05D 1/18

(52) U.S. Cl. 427/8; 106/287.18; 427/431; 427/162

(57) ABSTRACT

This invention is directed to methods of plating, plating baths, and articles with coatings which permit secure identification and/or authentication of coated or plated product. The coatings include composite coatings with particulate matter within a metallic matrix where said particulate matter has identification and/or authenticating properties. Articles with composites coatings incorporating more than one particulate matter and/or more than one coating layer are also disclosed.

This application claims priority to U.S. Provisional Patent Application No. 61/400,203, filed on Jul. 23, 2010, incorporated herein in its entirety.

### BACKGROUND OF THE INVENTION

A. Field of the Invention

This invention pertains to articles with a coating as a means for identifying and/or authenticating the articles, as well as methods and compositions for making the same.

B. Description of the Prior Art

In general the plating of articles with a composite coating bearing finely dispersed particulate matter is well documented. This technology has been widely practiced in the field of electroplating as well as in the field of electroless plating. The acceptance of such composite coating stems from the recognition that the inclusion of fine particulate matter within metallic matrices can significantly and positively alter the properties of the coating such as a means of changing surface characteristics of articles, such as by adding a coat with wear resistance, lubricity, friction, thermal transfer capability, and to improve appearance.

The most common methods of plating are electrolytic, electroless (also known as auto-catalytic or chemical plating), and brush. Electroless composite technology is a more recent development as compared to electrolytic composite technology. The fundamentals of composite electroless plating are documented in a text entitled “Electroless Plating Fundamentals and Applications,” edited by G. Mallory and J. B. Hajdu, Chapter 11, published by American Electroplaters and Surface Finishers Society (1990). Such conventional plating is commonly used for purposes such as corrosion protection, aesthetics, and wear resistance. Composite plating with particulate matter within the plated layer is widely used for hardness, wear resistance, frictional, lubricating, and other properties, but nowhere in the prior art has particles been incorporated into plated layers so that plated articles can be individually identified or authenticated by covert means incorporated in the plating. Articles with a composite plated coating incorporating certain particles allow the article to be identified, authenticated, tracked, etc. Such coatings may be in addition to other coatings on said articles that serve alternative functionality.

There is a present need for means for identifying the source of articles or means of authenticating articles by incorporating authenticating particles in their cover coats. Previously known means for authentication usually involved making substantially physical changes to the article or attaching something to the article, such as adding non-removable tags with printed or other source-identifying indicia, etching or imprinting a surface of the article, adding additional components, such as RFID tags and so forth. Nowhere in the prior art are articles provided with a plated coating including particles so that the plated articles can be individually identified or authenticated by covert means incorporated in the plating. Articles with a composite plated coating incorporating certain particles allow the article to be identified, authenticated, tracked, etc.

Commercial uses of composite plating with particulate matter prior to the present invention were limited to coatings with particulate matter that is generally categorized as hard, wear resistant, lubricating, thermal transferring, insulating, and/or frictional. Feldstein in U.S. Pat. Nos. 5,514,479, 5,5.16,591, and 5,834,065 disclosed the inclusion of particles with light emitting properties into composite plated layers to create layers that can emit light for identification and authentication purposes. These three patents, directed to purposes associated with visual inspection, are inadequate for disclosing numerous commercial needs and applications because, among other reasons, they require substantial quantities of particles in order to permit visual identification and visual identification alone does not meet many current needs. Firstly, the Feldstein coatings are directed to introducing particles with indicators into the coating which become visible by the unaided human eye under traditional lighting. Also, these light emitting coatings require a significant quantity of light emitting particles to be co-deposited with a plated coating in order to provide the light emitting feature needed to be visible to the human eye. That is, because each particle emits a low quantity of lumens, many particles are needed for visibility. The quantity of particles required to be included in the coating is especially high to make such a coating's light emitting properties visible when it is being inspected with ultraviolet light while there is also extraneous ambient light from the sun, incandescent, fluorescent, LED, and other non-ultraviolet light sources. The requirement for a large percent of said particles in a coating poses a number of significant problems. It raises the cost of the coating process and the coating itself because the particles are typically expensive and appreciable quantities are needed. It affects the properties of the coating such as appearance, hardness, corrosion resistance, and others thereby impacting bath formulation and potentially bath stability. Moreover, even with a large percent of such particles incorporated into a coating, the coatings described in the Feldstein patents U.S. Pat. Nos. 5,514,479, 5,516,591, and 5,834,065 are vulnerable to diminishment of their light emitting properties over time as the particles are susceptible to being obscured by contaminants from individuals and the environment, especially on products frequently handled or used in industrial applications. The present invention's disclosure of a method of incorporating wear resistant particles and authentication particles into the same coating, provides an advantage of greater longevity of the authentication properties of the coating by reducing or avoiding wear to the coating as well as significantly reducing the quantity of authenticating particles as the article ages or wears. The incorporation of more than one type of particulate matter into a coating requires modification and optimization of the plating bath in terms of, but not limited to, stabilizer(s) content, bath formulation, respective concentrations and ratios of the concentrations of the various particulate matters in the plating bath, agitation of the plating bath, movement of the articles being plated, etc.

Commercially viable composite electroless, and conventional electroless plating processes with particles, must operate at certain levels of performance in a number of parameters. Such parameters include: plating rate of the plating bath, surface area of immersed workpieces able to be plated per volume of the plating bath, stability of the plating bath, ability to replenish the plating bath with continued used of the plating bath, lifetime of the plating bath, usually described in terms of metal turnovers, and other parameters.

A further drawback of the coatings described in the Feldstein patents U.S. Pat. Nos. 5,514,479, 5,516,591, and 5,834,065 is that because the coatings are directed to visibility by the unaided human eye, the coatings are neither very covert, proprietary, nor customizable. Because uniqueness is essential to identification and authentication, all three of these characteristics are essential to practical use of coatings in identification and/or authentication applications. The technology disclosed in the Feldstein patents U.S. Pat. Nos. 5,514,479, 5,516,591, and 5,834,065 is readily available in the market, which means that a manufacturer cannot effectively maintain distinctive and secure identification in each coating, nor can these materials be modified or customized in order to allow a manufacturer to stay one step ahead of counterfeiters.

Other coatings and methods of producing coatings with identification and/or authentication properties exist as well. Aside from the Feldstein patents U.S. Pat. Nos. 5,514,479, 5,516,591, and 5,834,065 which are directed as disclosed above, other such methods include those applying paint, lacquers, varnish, laminates, holograms, and ink, among others. Such methods have been used for applying these finishes to packaging, consumer products, pharmaceuticals, textiles, currencies, and other products. However, these finishes and methods also lack the requisite benefits available in the present invention. Most notably, these finishes and methods lack the benefit of a low-cost and secure uniquely identifiable coating, with identification and/or authentication properties, that is uniformly metallurgically bonded to a substrate across a complex geometry, and is hard, durable, metallic, and conductive.

### BRIEF DESCRIPTION OF THE FIGURE

FIG. 1 shows a representation of an article with a coating as described in the invention, as well as a reader for authenticating the article.

### SUMMARY OF THE PRESENT INVENTION

There remains therefore an unresolved need for cost effective coatings with identification and/or authentication properties that require only small amounts of identifying particulate matter in order to provide such properties. There also remains an unresolved need for coatings with identification and/or authentication properties that are more covert and customizable.

The need for such a coating technology further relates to there being a global counterfeit epidemic. According to the World Customs Organization the problem costs manufactures about $512 billion worldwide. Everything from money to electronics, software, pharmaceuticals, clothing, watches, jewelry, automotive components, aircraft parts, documents, and all sorts of consumer products are frequently counterfeited.

Counterfeiting is a serious and growing epidemic in our global marketplace. The cost to consumers, manufacturers, and law enforcement is tremendous. There are unmet needs to authenticate and track products. The technology of the present invention represents a novel means of serving these needs.

Composite coatings with certain materials are able to provide multiple levels of overt and covert identification onto virtually any product. Electroless nickel is a well established method for composite coating, but other metals, alloys, and processes can also be used to incorporate highly specialized materials. The resulting coatings can embody phosphorescence, forensic markers, sound activating properties, and other properties. The ability to modify each method of identification and use multiple methods simultaneously means that the technology of the present invention can evolve to serve identification and authentication needs in a variety of ways and on an ongoing basis.

Manufacturers spend tremendous amounts to develop and market and enforce their brand names, reputations and intellectual property, and they are forced to spend similarly large sums of money and effort to protect their brands. Manufacturers confront brand and product problems from counterfeiters in various ways. In addition to imitation products being sold by retailers, distributors sell imitation products to retailers without the retailers' knowledge that the products are imitations. At times, authentic and imitation products are “mixed together” and the retailer is unaware that some of the inventory includes imitations. For example, until manufacturers receive goods returned for credit or repair they may be unaware of the presence of counterfeits and the on-going loss of business. Retailers also may not want to be selling imitations and have no way of knowing that imitations are included in their inventories. The need is so significant that many manufacturers are compelled to have extensive “Brand Protection” departments.

Consumers also have the need to know if the products they purchase are authentic or not. This need often relates to the desire to insure they are receiving the level of quality commensurate with the price they pay for an item. In addition to brand issues, depending on the product, there are often serious quality and safety implications if products or components are not authentic. Consider aircraft and automotive components as examples. Moreover, consumers would also benefit if the products they purchase were not inflated by the expense manufacturers have to pay to protect their brands.

Governmental agencies are also confronted with the challenge of counterfeiting. This can be seen in the tremendous efforts governmental agencies undertake to protect their currencies, national manufacturers and consumers from counterfeit imports through customs inspections, and even products used by governmental agencies such as the military where counterfeit components are prevalent. The present invention provides substantial utility to governmental agencies in these and other regards as well.

Specifically, it is desirable to provide a plating bath for coating, coatings, and methods for applying such coatings, in which the coating contain particles with unique identifying attributes.

Accordingly, there is still an unsolved need for a plating bath for coating, coatings, and methods for applying such coatings, in which the coating contain particles with unique identifying attributes.

In summary, there is a need for coatings and methods for affixing such coatings where the coatings include at least one type of reflective particle, fluorescent particle, or other particle which emits, fluoresces, or reflects light in various ways (collectively referred to herein as “emitting”), which radiate sound or some other recognizable frequency, or which provide the ability to display particular identifying information, and which in aggregate are uniformly embedded in the surface of a plated coating, and in which the plated coat is affixed to an article. In general, for purposes of security and authenticity, as described herein, either alone or in various combinations, the emittance properties of these particles are such that they are not readily discernable by visual inspection, such as being visible to an unaided naked eye, but become visible (or audible) under certain lighting or other conditions, or can be read by devices tuned to certain wavelengths or seeking certain intrinsic properties. Further, a plurality of such particles or types of such particles can be similarly embedded in the surface of a plated object so as to incorporate a mix which renders a potential encoding scheme, thereby increasing the security aspects. Further, the embedded particles-may further include additional particles which provide for additional properties, such as hardness or wear resistance. In order to embed such particles uniformly in a coating, the present invention is further directed to a plating solution and method for plating the solution, in which the particles are combined with other particles and compounds in such a way so as to assure uniformity in the plating process.

This invention relates to plating baths, articles, and methods of coating articles which can be identified or authenticated in part by a coating where said coating is a composite coating with particulate matter within a metallic matrix, where the matrix encompasses various additional elements for factors such as bath stability and assurance of uniformity in plating.

### DETAILED DESCRIPTION OF THE PRESENT INVENTION

The coating technology disclosed herein provides great utility in serving multiple important needs. In general, the coatings, and methods of applying the coatings described herein, include a matrix base with particulate matter, where the particulate matter is comprised of one or more chemicals included for the purpose of uniqueness of coating as well as for cost-effective commercial applicability. A number of varieties of composite coatings have been developed as part of the present invention to provide authentication properties. These include, but are not limited to, composite coatings encompassing unique indicators such as but not limited to phosphorescent particles, forensic markers, and sound activating triggers. These varieties can be used alone or in combination with one another for even greater levels of authentication and product protection.

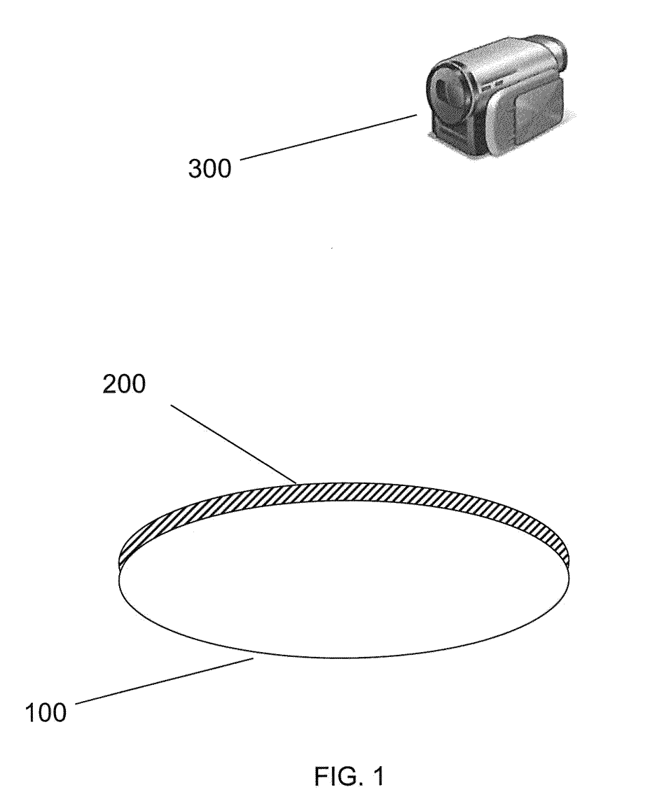

FIG. 1 shows a representation of the use of the coating in the present invention. As shown in FIG. 1, article 100 is coated with coating 200. Coating 200 includes particles with authenticating properties. Reader 300 is used to read the authenticating properties.

The plating bath used for plating a solution with such particles must be tightly controlled, and examples of such controlled plating baths are detailed below.

In the preferred embodiment, electroless nickel (“EN” or “composite EN”) is used as the matrix base in the development with each of these indicators (and with others as well). The properties of each of these authentication additives can be incorporated into coatings with EN as the base matrix, but can also be used with other plating baths having alternative base matrices.

Composite EN is a well established technology and is utilized now in countless applications around the world. The most common ones have been composite EN coatings with hard particles such as diamond for exceptional wear resistance, and composite EN coatings with Polytetrafluoroethylene or Boron Nitride for low friction and release properties.

These composite EN coatings include a key advantage, which is the ability to add a new or improved feature to the inherent composition properties of EN. Under appropriate plating conditions, all composite EN coatings are perfectly conformal to a substrate's geometry with strong adhesion, and provide hardness, corrosion resistance, etc. Composite EN coating processes are also consistent with regular EN in terms of pre-treatment, ability to do selective coating, bath operation, stripability, and waste treatment.

While electroless nickel as a base matrix has been well developed and commercialized in the art in non-authenticating applications, other varieties of electroless plating (such as electroless copper, cobalt, gold, platinum, silver, and the like) can alternatively be used to produce composite coatings with identification and authentication properties. Each of these metals can be plated by an electroless plating method in an alloy with secondary materials such as phosphorous, boron, and the like.

The electroplating method can alternatively be used to produce composite coatings with identification and authentication properties. Electroplating is commonly produced using metals and alloys thereof, such as chromium, nickel, gold, silver, rhodium, copper, tin, bronze, lead, zinc, and the like. The electroplating method is generally considered to have limitations in comparison to the electroless method because the electroplating method is generally not able to incorporate a high a percentage density or uniformity of particles in a coating as the electroless method. The electroless method is able to produce composite coatings that are routinely 25 to 50 percent particles that are uniformly distributed within the coating across all surfaces of the plated article. This general condition can be a limitation for the electroplating method in producing coatings for purposes such as wear resistance, lubricity, friction, heat transfer, etc. where a higher percentage of co-deposited particles is generally required. Therefore the use of the electroplating method is conducive to producing coatings for identification and authentication purposes as it is for composite coatings for many other purposes as the percentage of identification or authentication particulate matter that is required to yield identification and authentication properties is generally considerably less than the percentage of particles required in a coating to impart properties, such as wear resistance, lubricity, friction, heat transfer, etc.

In electroless plating processes, reducing agents are used as electron donors. When reacted with the free floating metal ions in the bath solution, the electroless reducing agents reduce the metal ions, which are electron acceptors, to metal for deposition onto the article. The use of a reducing agent avoids the need to employ a current, as required in conventional electroplating. Common reducing agents are sodium hypophosphite, nickel hypophosphite, sodium borohydride, n-dimethylamine borane (DMAB), n-diethylamine borane (DEAB), formaldehyde, and hydrazine.

Complexing agents may be needed as well. The complexing agent acts as a buffer to help control pH and maintain control over the “free” metal salt ions in the solution, all of which aids in sustaining a proper balance in the bath solution. Some of these complexing agents are, without limitation, lactic, malic, succinic, hydroxyacetic, acetic, ammonium compounds, citric.

In addition, particulate matter stabilizers may be useful for some applications. Examples of particulate matter stabilizers which may be useful include Sodium salts of polymerized alkyl naphthalene sulfonic acids, Disodium mono ester succinate, Potassium fluorinated alkyl carboxylates, Sodium n-Octyl Sulfate, Sodium di (2-ethyl-hexyl) sulfosuccinate, Potassium perfluoroalkyl sulfonates, Fluorinated alkyl polyoxyethylene ethanols, Sodium hydrocarbon sulfonate, Sodium lignin sulfonate, Sodium dodecylbenzene sulfonate, Disodium alkyl (8-18) amidoethanol sulfosuccinate, Sodium isopropylnaphthalene sulfonate, Tallow trimethyl ammonium chloride, Sodium salts of polymerized substituted benzoid alkyl sulfonic acids, Lauryl trimethyl ammonium chloride, Sodium alkyl sulfonate, and others.

In some cases, the electroless metallizing bath may further contain a pH adjuster to also help control pH levels in the bath. Suitable pH adjusters include, without limitation, carbonates, hydroxides, and acids that buffer at a desired pH range. Some of these pH adjusters are, without limitation, ammonium hydroxide, sodium hydroxide, potassium carbonate, ammonium bicarbonate, ammonium carbonate, and sulfuric acid. Again, the use and quantity of a pH adjuster depends on the acidity of the bath, which is based at least in part on the dispersion and the complexing agents used.

The article to be coated may be any substrate or material capable of being coated through composite electroless plating. Once completed, this electroless plating process results in an article with a coating containing metal or metal alloy.

Such as previously described herein, in the preferred embodiment, light emitting properties have been incorporated within electroless and electrolytic coatings. These coatings appear normal under traditional lighting and are indistinguishable from one another under the naked eye (sun, incandescent, fluorescent, etc.), but under an ultraviolet light, these coatings emit a distinct brightly colored glow. A person simply needs to shine an ultraviolet light on parts to display the light emission of such a composite coating. The emitted or reflected light includes characteristics so as to make the appearance unique, and thereby provide the opportunity to confirm the authenticity of the parts. As there are a number of materials that fluoresce under ultraviolet light, it is possible to produce a variety of composite coatings that each give off a different color glow when a ultraviolet light source is shined on the coating. For example, by incorporating a plurality of types of such particles, multiple wavelengths of light are emitted and a select combination are used with a particular good or line of goods so as to embed authenticity.

While the composite phosphorescent coatings described in U.S. Pat. Nos. 5,514,479, 5,516,591, and 5,834,065 are useful for some applications, the have the drawbacks described above, and other applications require an even greater need for covert authentication and avoidance of the limitations of such coatings. This can be accomplished in another embodiment by the use of certain forensic markers which are a family of materials that have been developed using unique substances or collections of substances so that each can be detected by an electronic meter, such as but not limited to a spectrophotometer. By utilizing a photo-oriented test, by detecting the uniqueness of the composition, one can discern whether the object is genuine or counterfeit. The test is non-invasive, instantaneous, and infinitely repeatable. These materials are chemically inert, safe and strong enough to persist in almost any conditions including plating baths, other methods of coating, and heat treatment. Only small amounts of these materials, often ceramic based, need to be co-deposited into a coating to make their properties evident to the electronic meter. Therefore the slight presence of the material in the coating is not readily visible and essentially does not affect the performance of the coating in other regards. Still other embodiments include use of various other particles which emit selected wavelengths of light, particles with phosphorescent characteristics, particles which reflect light, sound-related particles, radio wavelength-emitting particles, and particles which include other uniquely identifiable characteristics. Clearly, the combined use of a plurality of types of such markers, such as combining fluorescent and forensic markers, enhances the uniqueness possibilities.

There are a large number of such materials which can be used alone or in combination to create a unique marking or tracking system that can be embedded in almost any material or coating including electroless, electrolytic, and other methods of plating and coating. This makes possible many new opportunities for product management, manufacturing process and logistics control, inventory management, quality assurance, pollution control and authentication.

Each detectable material can be assigned a code number or a name. The electronic detector can be programmed to recognize each material and indicate the presence or absence of one or multiple materials according to the pre-assigned code. For example, if a coating is produced with material “1”, the detector will report the presence of “1” in the coating. If the coating contains material “2”, the detector will report “2”. If the coating contains both “1” and “2”, the detector will report both “1” and “2”. Similarly, the detector can respond to the presence of one or more materials in combination with the absence of one or more other materials.

This ability of the detector to identify multiple materials present and not present and the existence of many such identifiable materials means that numerous combinations can be employed within a coating, thereby allowing the opportunity to have coatings with embedded “codes” that indicate the authenticity of products and/or indications of the time, place, or other parameter of the products' manufacture.

Introducing such an authentication means is very useful to manufacturers both at the time of manufacture before product is transferred to their customers, as well as for tracking later on if any product is returned. Such capability can be particularly valuable for a manufacturer in warranty situations, especially if the returned product can be proven to not be authentic.

Preferably, the authenticating particles can be read with a digital meter, although other readers may also be used. Numerous security measures can be further incorporated into the digital meter itself such as special circuitry to prevent reverse engineering.

A further variety of authentication coating technology has been developed that allows the coating to activate a detector in the meter to produce an audible report. This method is similar to the method using forensic markers since only a small quantity of a specialized materials needs to be incorporated into the coating to trigger the response of the detector. A value of this variety of authenticating technology is its simplicity. The test may be instantaneous and may generate a clear pass/fail indication. This is a benefit to the manufacturer to verify the proper functionality of the coating, and to the end user to authenticate a coated product. Moreover, the detector used for such a coating can be relatively small and battery operated for the economy and convenience of the user.

It is also within the scope of the present invention to incorporate radio frequency identification devices (RFID) within a metal matrix coating. RFIDs have the ability to impart identification and/or authentication properties that can be precisely customized for extensive utility. Use of moderate temperature coating processes have particular benefit for the inclusion of such RFIDs.

In the preferred embodiment of the coatings of the present invention, a solution is formed incorporating particulate matter into an electroless nickel-phosphorous alloy plated layer, whereby the particles in the particulate matter are about 1-10 microns in size, are in a concentration on the layer of about 2 percent by volume, and can be detected from the surface of said layer by a device such as spectrophotometer. The coating is applied in an application of the solution using known techniques, customized for the particles and the quantities used in the coating. In this preferred embodiment, the particulate matter becomes uniformly distributed within the layer in terms of particle size and concentration by volume. So that a suitable detector would be able to detect the presence, and potentially concentration, of the particulate matter within the coating the particulate matter will be generally uniformly distributed within the coating and the coating will be generally consistent from one area of the plated object to another. In the preferred embodiment, the particulate matter may be formed of luminescent materials such as those disclosed in United States Patent Application Publication No. 2009/0084981 by Brown et al.

Articles on which such identification and authentication coatings may be useful include, but are not limited to, parts and products that are commonly counterfeited such as monetary devices, components for aircraft and automotive, consumer products, apparel, watches, accessories, firearms, ammunition, safety and security equipment and devices; computer and electronic equipment, military equipment; etc. Articles may be made of metal or nonmetal materials, or may have metalized portions. Another improvement of the present invention is that the coatings disclosed herein can be applied to metal and nonmetal articles with precise conformity and excellent adhesion.

Selection of the appropriate plating matrix, particulate material, method of application, and coating specifications will depend on factors related to each application such as use, size, geometry, substrate material, and others. As there are a wide variety of such coating combinations, such coatings can be tailored to the requirements of each application.

In some cases, the electroless metallizing bath may further contain a pH adjuster to also help control pH levels in the bath. Suitable pH adjusters include, without limitation, carbonates, hydroxides, and acids that buffer at a desired pH range. Some of these pH adjusters are, without limitation, ammonium hydroxide, sodium hydroxide, potassium carbonate, ammonium bicarbonate, ammonium carbonate, and sulfuric acid. Again, the use and quantity of a pH adjuster depends on the acidity of the bath, which is based at least in part on the PTFE dispersion and the complexing agents used.

The article to be coated may require preliminary preparation prior to this contact. This preparation includes the removal of surface contaminants. For example, this process may involve degreasing, alkaline cleaning, electrocleaning, water or solvent rinsing, acid activation, pickling, ultrasonic cleaning, physical modification of the surface, vapor or spray treatments, etc.

A wide variety of plating matrices could be used including numerous metals and alloys applied by electroless, electrolytic, and other methods. Incorporated into this plated layer could be a large variety of particulate materials including phosphorescent materials, forensic materials, sound activating material, and others. These are generalizations of the physical and chemical phenomena involved, and not provided herein to restrict or limit the scope of this invention.

Also included in this invention are articles with combination composite plated coatings incorporating more than one particulate material with identification and/or authentication properties. Such combination composite plated coatings will provide enhanced and/or multiple properties and/or synergistic benefits.

Another embodiment of the present invention involves the introduction of the various particulates for authentication described herein in a polytetrafluoroethylene (PTFE) base so as to provide a means for authentication in a PTFE-based coat. In a further embodiment, the present invention is directed to composite plating, composite plating compositions, articles plated in such compositions, and more particularly, to a process of composite plating with PTFE in a metal or alloy matrix where the materials used in the process contain no or essentially no PFOS (perfluorooctane sulfonate) and no PFOA (perfluorooctanoic acid).

Composite plating with PTFE is accomplished by adding appropriate amounts of a dispersion containing PTFE particles into the plating bath generally containing a metal such as electroless nickel. The PTFE dispersion is formulated to break up any agglomerates, such as of PTFE, resulting from the manufacture of the PTFE and encapsulate the PTFE particles with certain chemicals that allow the PTFE to be introduced and function properly in the plating bath.

According to the United States Environmental Protection Agency, “Perfluorooctanoic acid (PFOA), also known as “C8,” is a synthetic chemical that does not occur naturally in the environment. It has special properties that have many important manufacturing and industrial applications. The EPA has been investigating PFOA because PFOA is very persistent in the environment, is found at very low levels both in the environment and in the blood of the general U.S. population, remains in people for a very long time, and causes developmental and other adverse effects in laboratory animals. Major pathways that enable PFOA, in very small quantities, to get into human blood are not yet fully understood. PFOA is used to make fluoropolymers and can also be released by the transformation of some fluorinated telomers. However, consumer products made with fluoropolymers and fluorinated telomers, including Teflon® and other products, are not PFOA. Rather, some of them may contain trace amounts of PFOA and other related perfluorinated chemicals as impurities. The information that the EPA has available does not indicate that the routine use of consumer products poses a concern. At present, there are no steps that EPA recommends that consumers take to reduce exposures to PFOA. In 2006, EPA and the eight major companies in the industry launched the 2010/15 PFOA Stewardship Program, in which companies committed to reduce global facility emissions and product content of PFOA and related chemicals by 95 percent by 2010, and to work toward eliminating emissions and product content by 2015.”

Specifically, it is desirable to reduce or eliminate PFOA and PFOS from such systems while concurrently introducing particulate matter for authentication and identification purposes, as discussed herein.

Accordingly, there is still an unsolved need for further improvements in composite PTFE plating solutions and methods, whereby PFOS and PFOA are eliminated or greatly reduced concurrently with providing a means for authentication.

In electroless plating systems, the PTFE particles are dispersed with a combination of surfactants into a dispersion product. Commercially available dispersions are generally about sixty percent by volume PTFE solids. One or more of the surfactants used to date in such dispersions are fluorocarbon materials that contain PFOS. In the present invention, surfactants may be required for reasons of stability and/or uniformity when authenticating particles are introduced in a PTFE-based bath.

All composite PTFE plating solutions, in addition to other metallic matrix-based plating solutions, and methods known in the art, including the art referenced above, knowingly or unknowingly incorporate PFOS in the plating process. Specifically, PFOS is included in one or more of the surfactants or particulate matter stabilizers that are used to disperse PTFE particles and make them compatible with the plating process. PFOS has historically been used because the surfactants or particulate matter stabilizers most readily available, common in the composite plating field, and effective for this application contain PFOS. PFOS containing materials have been the industry standard in such PTFE dispersions and plating baths due to the high level of stability which the PFOS material provides to both the PTFE dispersion alone and to the performance of the composite plating bath using PTFE from such dispersions. PFOS is a molecule containing eight carbon atoms and sixteen fluorine atoms. The electronegativity of the fluorine atom helps a surfactant adsorb onto particles such as PTFE. Shorter carbon chain surfactants contain fewer fluorine atoms and are therefore less effective than an eight chain PFOS surfactant. For example, a six carbon chain surfactant contains only twelve fluorine atoms as there are two fluorine atoms for every one carbon atom. For the purposes of this discussion, a surfactant is meant to include all varieties of surfactants, wetting agents, dispersants, particulate matter stabilizers and like materials. A surfactant with less electronegativity than provided in a PFOS surfactant will be less able or impossible to adsorb onto PTFE particles. A modified dispersion formulation and/or process may be needed to get a surfactant with less electronegativity than PFOS to adsorb onto PTFE particles, if it is even possible, with equal strength. Surfactants with less electronegativity include fluorocarbon surfactants with less than eight carbon atoms, hydrocarbon surfactants, and others. If the surfactants used in the dispersion of the PTFE particles have less electronegativity than that provided by PFOS, and the adsorption onto the PTFE is weaker than what it would be with a PFOS surfactant, the PTFE dispersion will be less stable, meaning that the PTFE will be more prone to settling, floating, or otherwise de-wetting, and hence not being a stable dispersion able to handle shelf life, storage, transportation, temperature changes in the above. Such a dispersion would also not be in suitable condition for use in a plating bath. In the plating bath, stability of the PTFE from a dispersion using surfactants with less electronegativity than PFOS surfactants can also be lower, and hence exhibit drawbacks or failures such as the de-wetting of PTFE particles in the plating bath. De-wetting of the PTFE particles in the plating bath is most commonly witnessed by the PTFE particles agglomerating within the plating bath and/or floating on top of the surface of the plating bath. Factors such as high temperatures, chemistry, and agitation make the PTFE particles more likely to de-wet in the plating bath. Naturally, if the PTFE particles float, agglomerate or otherwise de-wet in the plating bath, these particles will not be useful in the plating bath for co-deposition as desired onto an article. Adding more PTFE dispersion into a plating bath to compensate for de-wetted particles is a costly and likely ineffective option as the newly introduced PTFE particles are likely to also de-wet, and the additional PTFE dispersion introduced to the plating bath may negatively affect the performance of the plating bath.

PFOA is a polymerization aid used in the manufacture of PTFE, and some concentration of PFOA is generally included in PTFE used in plating. Use of PFOA as a polymerization aid in the manufacture of PTFE has certain significant influences and advantages in PTFE dispersions in composite plating baths, and on articles produced from such plating baths.

When the PTFE particles are produced, they are produced with PFOA as a polymerization aid. It is possible however to modify the process of PTFE manufacturing to produce PTFE with essentially no, or no PFOA, and to then create a dispersion of the PTFE particles essentially free or free of PFOA. Some manufacturers of PTFE have been able to reduce the PFOA content of their PTFE products suitable for PTFE dispersions to trace levels. Other manufacturers have programs in place to do the same to eliminate or essentially eliminate PFOA in their PTFE.

The formulations and methods of producing PTFE dispersions established in the field of composite plating have been based on the properties of PTFE particles manufactured with PFOA as a polymerization aid. As has been discussed, the dispersion and use of such PTFE dispersions in composite plating is a sensitive balance requiring significant adsorption of surfactants onto PTFE particles which are not readily wetable. The type, composition, charge, particles size, degree of agglomeration, surface area, and other factors are essential in the degree of stability or instability of the PTFE particles within a dispersion and/or plating bath. Moreover, the coordination between the quantity, combinations, and charges of the surfactants and the type, composition, charge, particles size, degree of agglomeration, surface are, and other factors of the PTFE particles is essential to the ultimate stability and utility of the PTFE in the dispersion and/or plating bath. Any alteration to one of the materials may require adjustment to some, or all of the other parameters, if even possible, to still produce an effective product, process, and article from such a process. In terms of PFOA specifically, its use as a polymerization aid affects the composition of the PTFE, the base particle and/or agglomerate size of the PTFE material. PTFE particles manufactured with less or no PFOA require different surfactants, combinations of surfactants and/or methods of dispersion in order to make such PTFE suitable for use in a dispersion and subsequent plating bath.

E.I. du Pont de Nemours and Company is a leader in the manufacture of PTFE, and has begun replacing the use of PFOA in the manufacture of PTFE with another material known as GenX. Gen X has the following chemical structure: CF₃CF₂CF₂OCF(CF₃)COOH.NH₃. Other products similar to Gen X in that they are usable in PTFE plating and do not include PFOA have also recently begun to appear in the marketplace.

PFOA and PFOS have recently become the topic of health and environmental concerns. These materials have been found to not decompose over time and are believed to have negative health and environmental impacts. Both materials have been found in human and animals' blood around the world, and it is a concern that these materials persist without decomposing. Terms like biocumulative and biopersistent have been used to describe PFOA and PFOS.

Therefore, an object of the present invention is PTFE dispersions useful in composite plating where these dispersions are free or essentially free of PFOA and/or PFOS while concurrently introducing particulate matter for authentication and identification purposes, as discussed herein.

In accordance with one embodiment of the present invention, there is described a process of electrolessly metallizing an article to provide on its surface a metal coating containing PTFE particulate matter, in which the PTFE dispersion and electroless metallizing bath are essentially free of PFOA and PFOS and additional particulate matter for purpose of authentication is included as well.

It is also within the scope of this invention to incorporate materials into coatings such as powder coat, physical vapor deposition, chemical vapor deposition, brush plating, anodizing, conversion coatings, and other coatings.

It is also within the scope of this invention to incorporate additional particulate material of other purposes such as hardness, wear resistance, friction, lubricity, light emitting, flame retardant and others within the coating in addition to the identification and/or authentication material(s) to provide additional functional properties.

### EXAMPLES

### Example 1

A one-liter solution of the electroless nickel-phosphorous plating bath commercially available as NiPlate® 830 from Surface Technology, Inc. of Trenton, N.J. was prepared according to the manufacturer's specifications. To this bath was added 0.5 grams of a particulate material known as Code 8 from DataTrace of Frenchs Forest, NSW, Australia. The particles were dispersed in the plating bath for five minutes. The plating bath was then heated to 85 degrees Celsius. A steel panel weighing approximately three grams with a surface area of about 20 square centimeters was cleaned and immersed in the plating bath. After 32 minutes of plating time, the coated panel was removed from the plating bath, rinsed and dried. A cross section of the coated panel was made, and microscopic examination revealed that the coating contained Code 8 particles within the metal matrix. Testing of the coating with an electronic detector known as the P1 Reader from DataTrace of Frenchs Forest, NSW, Australia demonstrated the presence of Code 8 particles within said coating at an intensity level of 122.

### Example 2

A one-liter solution of the electroless nickel-phosphorous plating bath commercially available as NiPlate® 830 from Surface Technology, Inc. of Trenton, N.J. was prepared according to the manufacturer's specifications. To this bath was added 100 ml of Composite Diamond Coating CDC-D-2 diamond dispersion product from Surface Technology, Inc. of Trenton, N.J., and 3.5 grams of a particulate material known as Code 8 from DataTrace of Frenchs Forest, NSW, Australia. The particles were dispersed in the plating bath for five minutes. The plating bath was then heated to 85 degrees Celsius. A steel panel weighing approximately three grams with a surface area of about 20 square centimeters was cleaned and immersed in the plating bath. After 32 minutes of plating time, the coated panel was removed from the plating bath, rinsed and dried. A cross section of the coated panel was made, and microscopic examination revealed that the coating contained both diamond and Code 8 particles within the metal matrix. Testing of the coating with an electronic detector known as the P1 Reader from DataTrace of Frenchs Forest, NSW, Australia demonstrated the presence of Code 8 particles within said coating at an intensity level of 26.

Example 3

A one-liter solution of the electroless nickel-phosphorous plating bath commercially available as NiPlate® 830 from Surface Technology, Inc. of Trenton, N.J. was prepared according to the manufacturer's specifications. To this bath was added 0.5 grams of a particulate material known as Upconverter from DataTrace of Frenchs Forest, NSW, Australia. The particles were dispersed in the plating bath for five minutes. The plating bath was then heated to 85 degrees Celsius. A steel panel weighing approximately three grams with a surface area of about 20 square centimeters was cleaned and immersed in the plating bath. After 32 minutes of plating time, the coated panel was removed from the plating bath, rinsed and dried. A cross section of the coated panel was made, and microscopic examination revealed that the coating contained Upconverter particles within the metal matrix. Testing of the coating with an electronic detector known as the Upconverter Detector from DataTrace of Frenchs Forest, NSW, Australia produced an audible electronically generated sound which confirmed the presence of Upconverter particles within said coating.

### Example 4

A one-liter solution of the electroless nickel-phosphorous plating bath commercially available as Illumi-Layer™ from Surface Technology, Inc. of Trenton, N.J. was prepared according to the manufacturer's specifications including a dispersion of particles having light emitting properties and 3.5 grams of a particulate material known as Code 8 from DataTrace of Frenchs Forest, NSW, Australia. The particles were dispersed in the plating bath for five minutes. The plating bath was then heated to 86-88 degrees Celsius. A steel panel weighing approximately three grams with a surface area of about 20 square centimeters was cleaned and immersed in the plating bath. After 40 minutes of plating time, the coated panel was removed from the plating bath, rinsed and dried. A cross section of the coated panel was made, and microscopic examination revealed that the coating contained both said light emitting particles and Code 8 particles within the metal matrix. Testing of the coating with an electronic detector known as the P1 Reader from DataTrace, of Frenchs Forest, NSW, Australia demonstrated the presence of Code 8 particles within said coating at an intensity level of 18. Upon visual examination of the surface of the coating under ultraviolet light having a wavelength of 254 nanometers, a white glow was observed from the surface of the coating, thereby reconfirming revealed the presence of light emitting particles within the coating.

1. An article with a coating formed thereon, said coating comprising particulate matter within a metal matrix wherein said particulate matter is distributed within said coating and said particulate matter includes a marker which may be used to authenticate said article and which said marker's authenticating property is not visible to a naked eye.

2. The article of claim 1, wherein said particulate matter is metallurgically bonded to said article.

3. The article of claim 1, wherein said marker emits light.

4. The article of claim 3, in which said light is in the ultraviolet band.

5. The article of claim 1, in which said marker is a forensic marker.

6. The article of claim 1, in which said marker responds to sound activation.

7. The article of claim 1, in which, upon activation of said marker, an image appears on a reader so as to indicate authenticity or non-authenticity.

8. The article according to claim 1, wherein said metal matrix is applied by an electroless plating method.

9. The article according to claim 1, wherein said metal matrix is applied by an electrolytic plating method.

10. The article according to claim 1, wherein said metal matrix includes nickel metal.

11. The article according to claim 1, wherein said metal matrix is electrolytic nickel.

12. The article according to claim 1, wherein said coating contains more than one particulate matter with identification and/or authentication properties.

13. A method for encoding an article in plating, comprising the steps of
introducing particulate matter within a metal matrix,
formulating said metal matrix in a plating bath,
plating said article in said bath,
wherein said particulate matter includes a, marker which may be used to authenticate said article and which said marker's authenticating property is not visible to a naked eye.

14. The method of claim 13, wherein said particulate matter is metallurgically bonded to said article.

15. The method of claim 13, wherein said marker emits light.

16. The method of claim 13, in which said marker is a forensic marker.

17. The method of claim 13, in which said marker responds to sound activation.

18. The method of claim 13, in which, upon activation of said marker, an image appears on a reader so as to indicate authenticity or non-authenticity.
